(19) United States
(12) Patent Application Publication
(10) Pub. No.: US 2007/0152741 A1
(43) Pub. Date: Jul. 5, 2007

(54) CMOS BANDGAP REFERENCE CIRCUIT

(75) Inventors: Gabriel Alfonso RINCON-MORA, Atlanta, GA (US); Matthias ARNOLD, Hallbergmoos (DE)

Correspondence Address: TEXAS INSTRUMENTS INCORPORATED, P O BOX 655474, M/S 3999, DALLAS, TX, 75265, US

(73) Assignee: TEXAS INSTRUMENTS DEUTSCHLAND G.M.B.H., Freising (DE)

(21) Appl. No.: 11/539,361

(22) Filed: Oct. 6, 2006

(30) Foreign Application Priority Data
Aug. 19, 2005 (DE) 10 2005 039335.7

(51) Int. Cl. G05F 1/10

(52) U.S. Cl. 327/539

(57) ABSTRACT

A CMOS Bandgap reference circuit (100) provides an output reference voltage (V_{OUT}) with a defined temperature coefficient and comprises a PTAT current generator (102), providing a PTAT current (Iptat) with a positive temperature coefficient. The PTAT current generator (102) includes a first current path (A) with a first pn-junction diode (104) and a second current path (B) with a second pn-junction diode (110); and further includes a first current mirror (115), comprising a first mirror FET (116) with a channel (120, 124) connected in the first current path (A) and a gate (128) connected to a first mirror node (122), and a second mirror FET (118), with a channel (130, 134) connected in the second current path (B) and a gate (136) connected to the first mirror node (122). The first current mirror (115) provides the same current (Iptat) in both the first and the second current paths (A, B). A third current path (C) includes an amplifier FET (158) copying the PTAT current generator current (Iptat) to the third current path (C). A fourth current path (D) includes a third pn-junction diode (190), providing a junction voltage (V_{BE}) with a negative temperature coefficient. A second current mirror includes a third mirror FET (172) and a fourth mirror FET (180) mirroring a multiple (k*Iptat) of the PTAT current generator current (Iptat) from the third current path (C) to the fourth current path (D). The fourth current path (D) further includes a conversion resistor (196) connected in series with the third pn-junction diode (190), transferring the multiple (k*Iptat) of the PTAT current (Iptat) into a voltage (Vptat) that is added to the junction voltage (V_{BE}) to make the output reference voltage (V_{OUT}). The second current mirror further includes a feedback path to the PTAT current generator (102), with a first feedback FET (140) and a second feedback FET (142) connected to provide the same potential for the first current mirror (115) in the first and second current paths (A, B).

The invention relates to a low voltage, low power CMOS bandgap reference circuit comprising a PTAT generator and a pn-junction diode providing a junction voltage V_{BE} with negative temperature coefficient.

### BACKGROUND

A bandgap reference circuit uses the different temperature coefficients from a voltage source with proportional-to-absolute temperature (PTAT) characteristics and, on the basis of the emitter voltage of a bipolar transistor, provides a highly stable temperature-compensated voltage. In normal CMOS (complementary metal-oxide-semiconductor) processes, typically, only vertical bipolar structures serving as pn-junction diodes are available.

FIG. 1 (Prior Art) shows an example CMOS bandgap circuit 10 of a type found in various textbooks. The bandgap circuit 10 comprises junction diodes 12, 14 and a current mirror including field effect transistors (FETs) 16, 18 with two current paths A and B. Resulting from different current densities in the pn junctions in current paths A and B, a current Ip is generated with a positive temperature coefficient.

A multiple k*Ip of the current Ip is mirrored through a second current mirror 20 and 22 into a third current path C and transferred by a resistor 24 into a voltage Vₚ=k*Ip*R, with R being the resistance of resistor 24. The voltage Vₚ with the positive temperature coefficient is added to the pn-junction voltage V_{BE} of the diode 26. Since the pn-junction voltage V_{BE} has a negative temperature coefficient, by appropriate choice of the factor k, it is possible to obtain a temperature independent reference voltage Vref=k*Ip*R+V_{BE}.

The performance of this circuit is, however, not satisfying because of different potentials at nodes 30 and 32, which cause systematic mismatch of currents in both branches as well as different leakage currents through parasitic diodes indicated with dashed lines in FIG. 1. Common solutions to solve these issues involve using operational amplifiers (op-amps) to keep the potentials at nodes 30 and 32 identical. Including an op-amp, however, raises other problems. Apart from increasing complexity of the circuit, process variations may cause an unpredictable offset. To avoid these effects, at least the input stage of the op-amp has to be bipolar, but bipolar transistors are not available in standard CMOS processes.

### SUMMARY

The invention provides a straightforward low voltage, low power and compact bandgap reference circuit able to fabricated utilizing only components available in a basic CMOS process.

In accordance with a described embodiment, a CMOS bandgap reference circuit comprises a PTAT current generator which provides a PTAT current (Iptat) having a positive temperature coefficient. The PTAT current generator includes a first current path with a first pn-junction diode and a second current path with a second pn-junction diode. The PTAT current generator further includes a first current mirror, comprising a first mirror FET, with a channel connected in the first current path and a gate connected to a first mirror node, and a second mirror FET, with a channel connected in the second current path and a gate connected to the first mirror node. The first current mirror provides for the same current to flow in both the first and the second current paths. The bandgap reference circuit further comprises a third current path with an amplifier FET. The amplifier FET has a gate connected to the PTAT current generator and copies the PTAT current to the third current path. The bandgap reference circuit further comprises a fourth current path with a third pn-junction diode providing a junction voltage V_{BE} having a negative temperature coefficient. A second current mirror includes a third mirror FET, with a channel connected in the third current path and a gate connected to a mirror node, and a fourth mirror FET, with a channel connected in a fourth current path and a gate connected to the feedback mirror node. The second current mirror mirrors a multiple of the PTAT current from the third current path to the fourth current path. The fourth current path further includes a resistor connected in series with the third pn junction diode for transferring the multiple of the PTAT current into a voltage that is added to the junction voltage V_{BE} to provide the output reference voltage V_{OUT}. The second current mirror further includes a first feedback FET with a channel in the first current path and a gate connected to the feedback node; and a second feedback FET with a channel in the second current path of the PTAT current generator and a gate connected to the feedback node. The first and the second feedback FETs form a feedback path to provide the same potential for the first current mirror in the first and the second current path. The amplifier FET further provides a control for the output current path D via the second current mirror consisting of the third mirror FET and the fourth mirror FET. The amplifier FET forms an active amplifying element and offers a high loop gain, leading to a higher accuracy in stabilizing the reference voltage. The third current path can be shared for both the feedback loop and the control of the output current path. The feedback path provides a high supply rejection resulting in a good stability against supply voltage variation.

### BRIEF DESCRIPTION OF THE DRAWINGS

Further advantages and features of the invention will become apparent from the following detailed description of a preferred embodiment, with reference to the accompanying drawings, wherein:

FIG. 1 (Prior Art) is a schematic diagram of a CMOS bandgap reference circuit according to the prior art; and

FIG. 2 is a schematic diagram of an example embodiment of a CMOS bandgap reference circuit according to the principles of the invention.

### DETAILED DESCRIPTION OF EXAMPLE EMBODIMENTS

The illustrative CMOS bandgap reference circuit 100 of FIG. 2 includes a PTAT current generator 102 for providing a proportional-to-absolute temperature (PTAT) current Iptat which has a positive temperature coefficient. The PTAT current generator 102 comprises a first current path A, including a first pn-junction diode 104 having an anode 106 and a cathode 108 connected to ground, and a second current path B, including a second pn-junction diode 110 having an anode 112 and a cathode 114 connected to ground. The first current path A and the second current path B are coupled via a first current mirror 115 comprising a first mirror FET 116 and a second mirror FET 118. The first mirror FET 116 that has a drain terminal 120 connected to a first mirror node 122, a source terminal 124 connected to the anode 106 of the first pn-junction diode 104 via a series resistor 126, and a gate terminal 128 which is connected to the first mirror node 122 and therefore shorted to the drain terminal 120. The second mirror FET 118 has a drain terminal 130 connected to a second mirror node 132, a source terminal 134 connected to the anode 112 of the second pn-junction diode 110, and a gate terminal 136 connected to the gate terminal 128 of the first FET 116 and to the first mirror node 122. The FETs 116, 118 in the given example implementation are of NMOS type.

The PTAT generator 102 further comprises a first feedback FET 140 for the current path A, and a second feedback FET 142 for the current path B. The first feedback FET 140 has a drain terminal 144 connected to the first mirror node 122, a source terminal 146 connected to a supply voltage V_{DD}, and a gate terminal 148 connected to a feedback node 150. The second feedback FET 142 has a drain terminal 152 connected to a second mirror node 132, a source terminal 154 connected to the supply voltage V_{DD} and a gate terminal 156 connected to the feedback node 150. The FETs 140, 142 in the given example implementation are of PMOS type.

An amplifier FET 158 is arranged in a third current path C. The amplifier FET 158 has a drain terminal 160, connected to a node 162, a source terminal 164 connected to a summation node 166, and a gate terminal 168 connected to the second mirror node 132. A first compensation capacitor 170 is connected between the gate terminal 168 of the amplifier FET 158 and ground. The FET 158 in the given example implementation is of NMOS type.

The third current path C further includes a third mirror FET 172, having a drain terminal 174 connected to the node 162, a source terminal 176 connected to the supply voltage V_{DD} and a gate terminal 178 which is connected to the feedback node 150 and shorted to the drain terminal 174. The FET 172 in the given example implementation is of PMOS type.

In a fourth current path D, which is the output current path, a fourth mirror FET 180 is arranged to form a second current mirror together with the third mirror FET 172, for coupling the third current path C to the output current path D. The fourth mirror FET 180 has a drain terminal 182 connected to an output node 184, a source terminal 186 connected to the supply voltage V_{DD}, and a gate terminal 188 connected to the feedback node 150. The FET 180 in the given example implementation is of a PMOS type

A third PN junction diode 190, which provides a junction voltage V_{BE} with a negative temperature coefficient, has a cathode 192 connected to ground and an anode 194 connected to the summation node 166. A conversion resistor 196 is connected between the output node 184 and the summation node 166. An output compensation capacitor 198 is connected between the output node 184 and ground.

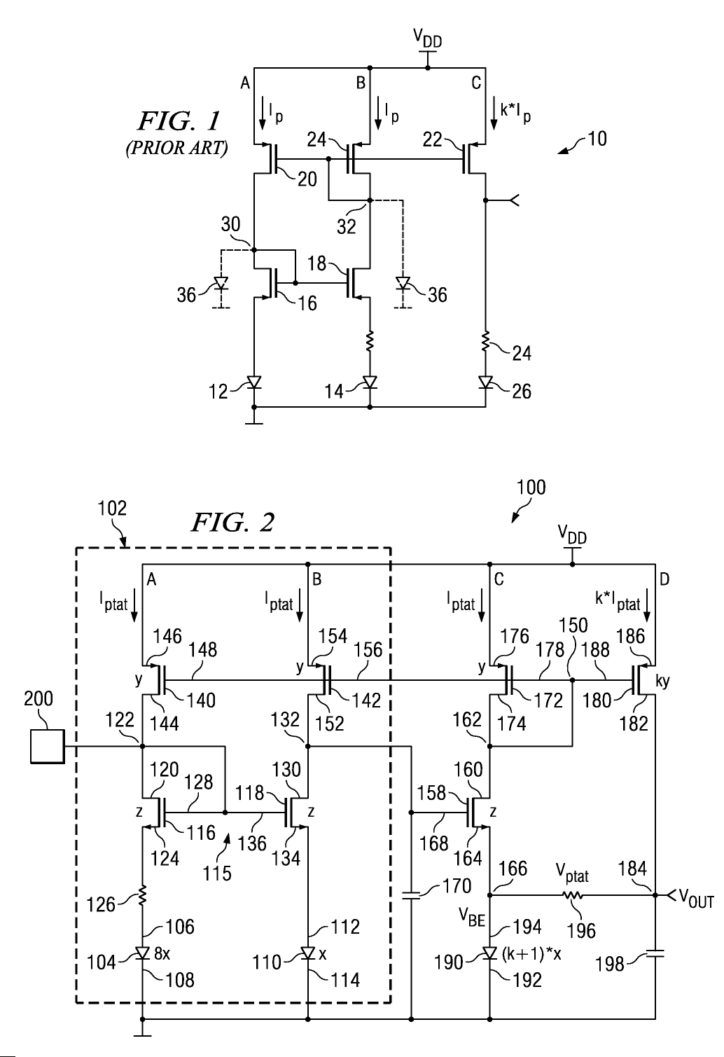

To implement the circuit, groups of FETs and diodes are formed which have matched design parameters, e.g., dimensions (W/L). FIG. 1 shows the FETs and the pn-junction diodes with identifiers “x”, “y” and “z”, to illustrate respective groupings. For example, the first mirror FET 116, the second mirror FET 118 and the amplifier FET 158 are matched to provide identical current densities, indicated by the identifier “z”. In the same way, the first feedback FET 140, the second feedback FET 142, and the third mirror FET 172 are matched, as indicated by the identifier “y”. The purpose of this matching is to provide the same current Iptat in all three current paths A, B and C.

The dimensions of the first pn-junction diode 104 and the second pn-junction diode 110 are also matched, but with a predetermined ratio in their parameters. In this embodiment, the dimension (“8x”) of the first pn-junction diode 104 is chosen to be eight times the dimension (“x”) of the second pn-junction diode 110. Therefore, the second pn-junction diode 110 has a current density which is eight times the current density in the first junction diode 104. As a result, the Iptat generator delivers a current Iptat with a positive temperature coefficient, which is copied into the third current path C by the amplifier FET 158.

By means of the second current mirror, formed by the third mirror FET 172 and the fourth mirror FET 180, the current Iptat is mirrored into the fourth current path D. However, because the third mirror FET 172 and the fourth mirror FET 180 are designed with different dimensions, providing a ratio in current densities of y: k*y, the current mirrored into the output current path D is k*Iptat.

The third pn-junction diode 190 experiences both the current Iptat from current path C and the current k*Iptat from the current path D. To have the same current density as in the second pn-junction diode 110, the third pn-junction diode 190 is dimensioned with a factor (k+1)*x relative to the second pn-junction diode 110. The third pn-junction diode 190 provides a junction voltage V_{BE} with a negative temperature coefficient.

The current k*Iptat in the output current path D flowing through the conversion resistor 196 causes a voltage drop Vptat=k*Iptat*R, having a positive temperature coefficient. At the output node 184, the voltage Vptat with the positive temperature coefficient is added to the pn-junction voltage V_{BE} with the negative temperature coefficient to provide an output voltage V_{OUT} at output terminal 184 having a value V_{OUT}=k*Iptat*R+V_{BE}. By appropriate choice of the factor k, the temperature coefficient of this output voltage V_{OUT} can be minimized or tailored for compensation purposes. Thus, the bandgap reference circuit 100 can provide an output voltage V_{OUT} with a very low temperature coefficient or with a temperature coefficient adjusted for compensation in an integrated or discrete circuit.

A negative feedback loop path is provided via the feedback node 150 by the second current mirror including the first and second feedback FETs 140, 142 of the PTAT generator. The feedback path ensures that the potentials at the first mirror node 122 and the second mirror node 132 are equal. In this way, a high supply rejection ratio can be achieved so that variations in the supply voltage will not affect the PTAT current Iptat in the current paths A to D.

Due to the high loop gain of the active amplification element formed by the amplifier FET 158, the amplification element can be shared for providing, first, a control for the output current path D via the second current mirror and, second, for the feedback loop via the feedback FETs 140 and 142. Another advantageous feature of the proposed circuit is the shared use of the third pn-junction diode 190 for both the third current path C and the output current path D. Parasitic capacitance at node 162 can constitute a second pole, but due to the low resistance in path C, this pole is shifted toward high frequencies.

In order to guarantee defined start-up operating conditions, a start-up unit 200 is connected to the node 122 in the first current path A to enable the injection of a starting current. The structure and function of such a start-up unit is well known to those skilled in the art.

The sharing of components for implementing different function conduits leads to a highly compact circuit design. Therefore, the proposed bandgap reference circuit has the important advantages of being area saving and being operable at a low quiescent current. Nevertheless, the proposed circuit offers a higher performance, i.e., in noise behavior, compared for example to conventional current mirror references. Op-amps are absent, so the circuit can be implemented in a basic CMOS process, avoiding the intrinsic noise occurring with PMOS technology.

Those skilled in the art to which the invention relates will appreciate that the foregoing detailed description of an example implementation is illustrative only, and that many variations thereof and many other embodiments exist within the scope of the claimed invention.

What is claimed is:

1. A bandgap reference circuit providing an output voltage (V_{OUT}) with a defined temperature coefficient, the circuit comprising:
a PTAT current generator for generating a PTAT current (Iptat) with a positive temperature coefficient; the PTAT current generator having a first current path with a first pn-junction diode, a second current path with a second pn-junction diode, and a first current mirror adapted, configured and connected for providing the same PTAT current (Iptat) in both the first and second current paths;
an amplifier FET having a source and drain connected in a third current path, a gate connected to the PTAT current generator, and adapted, configured and connected for copying the PTAT current (Iptat) to the third current path;
a third pn-junction diode connected in a fourth current path, and adapted and configured for providing a junction voltage (V_{BE}) with a negative temperature coefficient;
a second current mirror adapted, configured and connected for mirroring a multiple of the PTAT current (Iptat) from the third current path to the fourth current path, and for providing a feedback path to provide a same potential for the first current mirror in the first and the second current paths; and
a resistor connected in series with the third pn-junction diode in the fourth current path, and adapted, configured and connected, responsive to flow of the multiple of the PTAT current, for developing a voltage (Vptat) that is added to the junction voltage (V_{BE}) to provide the output voltage (V_{OUT}).

2. The circuit of claim 1, wherein the first, second, third and fourth current paths are connected in parallel between a supply voltage (V_{DD}) and ground.

3. The circuit of claim 1, wherein:
the first current mirror comprises a first MOSFET having its source and drain connected in the first current path, and a second MOSFET having its source and drain connected in the second current path and its gate connected to the gate of the first MOSFET; and
the second current mirror comprises a third MOSFET having its source and drain connected in the third current path, and a fourth MOSFET having its source and drain connected in the fourth current path and its gate connected to the gate of the third MOSFET.

4. The circuit of claim 3, wherein:
the second current mirror further comprises a fifth MOSFET having its source and drain connected in the first current path and its gate connected to the gate of the third MOSFET, and a sixth MOSFET having its source and drain connected in the second current path and its gate connected to the gate of the third MOSFET, the fifth and sixth MOSFETs forming the feedback path to provide the same potential in the first and the second current paths.

5. The circuit of claim 4, wherein the first and second MOSFETs are both one of either NMOS or PMOS type; and wherein the third, fourth, fifth and sixth MOSFETs are all the other of either NMOS or PMOS type.

6. The circuit of claim 5, wherein the amplifier FET is a MOSFET of the same type as the first and second MOSFETs.

7. The circuit of claim 6, wherein the first, second and amplifier MOSFETs are NMOS type; and wherein the third, fourth, fifth and sixth MOSFETs are of the PMOS type.

8. The circuit of claim 6, wherein the drain and gate of the first MOSFET are shorted, and wherein the gate and drain of the third MOSFET are shorted.

9. The circuit of claim 6, wherein the third and fourth current branches both include the third p-n junction diode.

10. The circuit of claim 9, wherein the gate of the amplifier MOSFET is connected to the drains of the second and sixth MOSFETs.

11. The circuit of claim 10, wherein a start-up current supply element is connected to the drains of the first and fifth MOSFETs.

12. The circuit of claim 11, wherein the first, second, third and fourth current paths are connected in parallel between a supply voltage (V_{DD}) and ground.

13. The circuit of claim 12, wherein an output compensation capacitor is connected between the drain of the fourth MOSFET and ground.

14. The circuit of claim 13, wherein another compensation capacitor is connected between the gate of the amplifier MOSFET and ground.

15. A bandgap reference circuit providing an output voltage (V_{OUT}) with a defined temperature coefficient, the circuit comprising:
a PTAT current generator for generating a PTAT current (Iptat) with a positive temperature coefficient; the PTAT current generator having a first current path with a first pn-junction diode, a second current path with a second pn-junction diode, and a first current mirror adapted, configured and connected for providing the same PTAT current (Iptat) in both the first and second current paths; the first current mirror comprising a first NMOSFET having its source and drain connected in the first current path and its gate shorted to its drain, and a second NMOSFET having its source and drain connected in the second current path and its gate connected to the gate of the first NMOSFET;
an amplifier NMOSFET having a source and drain connected in a third current path, having a gate connected to the drain of the second NMOSFET, and being adapted, configured and connected for copying the PTAT current (Iptat) to the third current path;
a third pn-junction diode connected in the third and in a fourth current path, and being adapted and configured for providing a junction voltage (V_{BE}) with a negative temperature coefficient; the third pn-junction having its anode connected to the source of the amplifier NMOSFET;
a second current mirror adapted, configured and connected for mirroring a multiple of the PTAT current (Iptat) from the third current path to the fourth current path, and for providing a feedback path to provide a same potential for the first current mirror in the first and the second current paths; the second current mirror comprising a first PMOSFET having its source and drain connected in the third current path with its drain shorted to its gate and connected to the drain of the amplifier NMOSFET, a second PMOSFET having its source and drain connected in the fourth current path and its gate connected to the gate of the first PMOSFET, a third PMOSFET having its source and drain connected in the first current path with its drain connected to the drain of the first NMOSFET and having its gate connected to the gate of the first PMOSFET, and a fourth PMOSFET having its source and drain connected in the second current path with its drain connected to the drain of the second NMOSFET and having its gate connected to the gate of the first PMOSFET; and
a resistor connected between the anode of the third pn-junction diode and the drain of the second PMOSFET;
whereby a voltage drop (Vptat) developed across the resistor, responsive to flow of the multiple of the PTAT current, is added to the junction voltage (V_{BE}) to provide the output voltage (V_{OUT}).

16. The circuit of claim 15, wherein a start-up current supply element is connected to the drains of the first and fifth MOSFETs.

17. The circuit of claim 15, wherein the first, second, third and fourth current paths are connected in parallel between a supply voltage (V_{DD}) and ground.

18. The circuit of claim 15, wherein an output compensation capacitor is connected between the drain of the second PMOSFET and ground.

19. The circuit of claim 18, wherein another compensation capacitor is connected between the gate of the amplifier NMOSFET and ground.

20. The circuit of claim 15, wherein the first and second NMOSFETs have matched W/L dimensions in a ratio of 1:1; and wherein the first, second, third and fourth PMOSFETs have matched dimensions in a ratio of 1:k:1:1, where k is a constant.
